(19) United States
(12) Patent Application Publication
(10) Pub. No.: US 2018/0202489 A1
(43) Pub. Date: Jul. 19, 2018

(54) DOUBLE-ROW SELF-ALIGNING ROLLER BEARING

(71) Applicant: NTN CORPORATION, Osaka (JP)

(72) Inventors: Michio HORI, Kuwana (JP); Yasuyuki INOUE, Kuwana (JP); Kazumasa SEKO, Kuwana (JP)

(73) Assignee: NTN CORPORATION, Osaka (JP)

(21) Appl. No.: 15/921,271

(22) Filed: Mar. 14, 2018

Related U.S. Application Data
(63) Continuation of application No. PCT/JP2016/076513, filed on Sep. 8, 2016.

(30) Foreign Application Priority Data
Sep. 17, 2015 (JP) 2015-184154
Sep. 17, 2015 (JP) 2015-184155
Sep. 17, 2015 (JP) 2015-184156
Sep. 17, 2015 (JP) 2015-184157
Sep. 24, 2015 (JP) 2015-186378

(51) Int. Cl. F16C 19/38; F16C 33/46; F16C 33/36

(52) U.S. Cl. CPC F16C 19/38; F16C 33/36; F16C 33/467

(57) ABSTRACT

A double-row self-aligning roller bearing includes an inner ring, an outer ring having a spherical raceway surface, and rollers in a left row and rollers in a right row interposed between the inner ring and the outer ring, the rollers in the left row and the rollers in the right row each having an outer peripheral surface having a cross-sectional shape along the raceway surface of the outer ring. The length of each roller in the left row and the length of each roller in the right row are different from each other, and the number of the rollers in the left row and the number of the rollers in the right row are different from each other.

### CROSS REFERENCE TO THE RELATED APPLICATION

This application is a continuation application, under 35 U.S.C. § 111(a), of international application No. PCT/JP2016/076513, filed Sep. 8, 2016, which claims priority to Japanese patent application Nos. 2015-184154, 2015-184155, 2015-184156, and 2015-184157, filed Sep. 17, 2015, and Japanese patent application No. 2015-186378, filed Sep. 24, 2015, the disclosure of which are incorporated by reference in their entirety into this application.

### BACKGROUND OF THE INVENTION

### Field of the Invention

The present invention relates to a double-row self-aligning roller bearing to be applied to a usage in which unequal loads are applied to rollers in left and right rows, for example, to a bearing for supporting a main shaft of a wind turbine generator, industrial machinery or the like.

### Description of Related Art

On a bearing that supports a main shaft of a wind turbine generator, an axial load due to wind force acts in addition to a radial load due to the weights of each blade and a rotor head. In the case where the bearing is a double-row self-aligning roller bearing, only rollers in one row among rollers in left and right rows mainly receive the axial load. In other words, the rollers in the left and right rows do not equally share load, and the row that receives the axial load bears greater total load. The rollers in the row that receives the axial load have shorter rolling fatigue life, and surface damage or wear thereof more easily occurs, as compared to the rollers in the row that hardly receives any of the axial load. The substantial service life of the entire bearing is limited by the rolling life of the rollers in the row that receives the axial load.

In order to improve the life of a bearing, only the load capacity of the entire bearing needs to be increased by using a bearing having a large size. However, in this case, only the rollers in the row that hardly receives any of the axial load have an allowance for the load capacity and the rolling life, so that the bearing becomes design-wise wasteful.

In view of the foregoing circumstances, as related art, for example, the following has been proposed as shown in FIG. 19: lengths L1 and L2 and contact angles of rollers 4 and 5 in left and right rows interposed between an inner ring 2 and an outer ring 3 are made different from each other thereby making the load capacity of the rollers 5 in the row that receives the axial load greater than the load capacity of the rollers 4 in the row that hardly receives any of the axial load (Patent Document 1). Specifically, the length L2 of the rollers in the row that receives the axial load is made longer, and the contact angle thereof is made greater. By appropriately setting the load capacities of the rollers 4 and 5 in the left and right rows as described above, the rolling life of the rollers 4 and 5 in the left and right rows becomes substantially the same, so that the substantial service life of the entire bearing can be improved.

### RELATED DOCUMENT

### Patent Document

[Patent Document 1] WO2005/050038

### SUMMARY OF THE INVENTION

However, the width dimension and the radial thickness of bearings are determined by standards, and thus the lengths and the magnitudes of the contact angles of the rollers in the left and right rows need to be determined in a limited space. Therefore, the degree of freedom in design is low, and it is difficult to design a bearing such that the load is shared in proportions corresponding to the load capacities of rollers in left and right rows in accordance with a radial load and an axial load received by the bearing. For example, when the length of the rollers in the row that receives the axial load is increased in order to increase the load capacity of this row, the length of the rollers in the other row becomes too short, so that the load capacity thereof for the radial load acting when a wind turbine stops may be insufficient.

An object of the present invention is to provide a double-row self-aligning roller bearing that can ensure a large load capacity in the entire bearing and can improve the substantial service life of the entire bearing, by sharing the load in proportions corresponding to the load capacities of rollers in left and right rows when loads having different magnitudes act on the left and right rows.

A double-row self-aligning roller bearing according to the present invention includes: an inner ring; an outer ring having a spherical raceway surface; and rollers in a left row and rollers in a right row interposed between the inner ring and the outer ring, the rollers in the left row and the rollers in the right row each having an outer peripheral surface of a cross-sectional shape along the raceway surface of the outer ring, in which a length of each roller in the left row and a length of each roller in the right row are different from each other, and the number of the rollers in the left row and the number of the rollers in the right row are different from each other.

According to this configuration, by making the length of each roller in the left row and the length of each roller in the right row different from each other, the rollers having a longer length have a greater load capacity than the rollers having a shorter length. In addition, by making the number of the rollers in the left row and the number of the rollers in the right row different from each other, a ratio between the load capacity of all the rollers in the left row and the load capacity of all the rollers in the right row changes as compared to that in the case where the numbers of the rollers in the left and right rows are equal to each other. Specifically, the load capacity of the roller row increases when the number of the rollers is increased. When the load capacities of the left and right roller rows are adjusted by using, in combination, the above configuration in which the lengths of the rollers are different from each other and the configuration in which the numbers of the rollers are different from each other, the degree of freedom in design becomes higher than that when the load capacities of the left and right roller rows are adjusted only by the method in which the lengths of the rollers are made different from each other. Thus, the load can be shared in proportions corresponding to the load capacities of the rollers in the left and right rows, even in a limited space in which a width dimension and a radial thickness are determined by standards. As a result, the surface pressures of the rollers in the left and right rows become uniform. Accordingly, a large load capacity can be ensured in the entire bearing, and also the substantial service life of the entire bearing can be improved.

The double-row self-aligning roller bearing is used in a usage in which loads having different magnitudes act on left and right rows, for example, in a usage in which one row receives an axial load and a radial load and the other row receives almost only the radial load. In this case, the rollers in the row that receives the axial load are made as the rollers having respective longer lengths, and the rollers in the row that hardly receives any of the axial load are made as the rollers having respective shorter lengths. In addition, the contact angle of each roller in the row that receives the axial load is made greater than that of each roller in the row that hardly receives any of the axial load. Accordingly, the rollers having a greater load capacity and the longer lengths receive both the axial load and the radial load, and the rollers having a smaller load capacity and the shorter lengths receive only the radial load. In addition to this, the ratio between the load capacity of all the rollers in the left row and the load capacity of all the rollers in the right row is adjusted by making the number of the rollers in the left row and the number of the rollers in the right row different from each other, whereby the load is substantially equally shared by the rollers in the left and right rows while a large load capacity is ensured in the entire bearing.

In one embodiment of the present invention, a maximum diameter of each roller in the left row and a maximum diameter of each roller in the right row may be different from each other. By making the maximum diameters of the rollers in the left and right rows different from each other, the ratio between the load capacity of all the rollers in the left row and the load capacity of all the rollers in the right row changes as compared to the case where the maximum diameters of the rollers in the left and right rows are equal to each other. That is, the load capacity of the roller row increases as the maximum diameter of the rollers increases. By using a method in which the maximum diameters of the rollers in the left and right rows are made different from each other in addition to the method in which the lengths of the rollers in the left and right rows are made different from each other and the method in which the numbers of the rollers in the left and right rows are made different from each other, the degree of freedom in design becomes higher, so that the load can be more easily shared in proportions corresponding to the load capacities of the rollers in the left and right rows while a large load capacity is ensured in the entire bearing.

In one embodiment of the present invention, the maximum diameter of each roller having a shorter length may be greater than the maximum diameter of each roller having a longer length. Generally, the load capacity increases as the length of each roller increases or as the diameter of each roller increases. By appropriately setting the lengths and the diameters of the rollers in the left and right rows, the load capacities of the rollers in the left and right rows have appropriate magnitudes, and the load can be shared by the rollers in the left and right rows in determined proportions. For example, in the case where the rollers having a longer length and a smaller diameter have a greater load capacity than the rollers having a shorter length and a greater diameter, the rollers in the row having a higher proportion in which the load is shared are made as the rollers having a longer length and a smaller diameter, and the rollers in the row having a lower proportion in which the load is shared are made as the rollers having a shorter length and a greater diameter.

Since the rollers having a longer length are entirely located on the inner diameter side relative to the rollers having a shorter length, when the maximum diameters of the rollers in the left and right rows are equal to each other, the thickness of the inner ring has an allowance at the side at which the rollers having a shorter length are present. By utilizing the thickness allowance, it is possible to make the diameter of each roller having a shorter length greater than the diameter of each roller having a longer length, even with the width dimension and the radial thickness determined by standards. By making greater the diameter of each roller having a shorter length, the load capacity of the entire bearing increases.

The double-row self-aligning roller bearing is used in a usage in which loads having different magnitudes act on left and right roller rows. In this case, by sharing the load in proportions corresponding to the load capacities of the rollers in the left and right rows, the surface pressures of the rollers in the left and right rows become substantially uniform. Accordingly, a large load capacity can be ensured in the entire bearing, and the substantial service life of the entire bearing can be improved.

In one embodiment of the present invention, the maximum diameter of each roller having a longer length may be greater than the maximum diameter of each roller having a shorter length. According to this configuration, by making the length of each roller in the left row and the length of each roller in the right row different from each other, the rollers having a longer length have a greater load capacity than the rollers having a shorter length. In addition, by making the diameter of each roller having a longer length greater than the diameter of each roller having a shorter length, the load capacity of the rollers having a longer length is greater than the load capacity of the rollers having a shorter length, by more than the difference in roller length. Therefore, in the case of setting the load capacities of the left and right rollers to have an appropriate ratio, the lengths of the rollers having a smaller load capacity do not need to be made shorter than necessary, and thus rotation stability thereof can be maintained.

The double-row self-aligning roller bearing is also used in a usage in which loads having different magnitudes act on left and right roller rows. In this case, the rollers in the row that receives a greater load are made as rollers having a longer length and a greater diameter, and the rollers in the row that receives a smaller load are made as rollers having a shorter length and a smaller diameter. By appropriately setting the lengths and the diameters of the rollers in the left and right rows, the load can be shared in proportions corresponding to the load capacities of the rollers in the left and right rows. As a result, the surface pressures of the rollers in the left and right rows become substantially uniform. Accordingly, a large load capacity can be ensured in the entire bearing, and the substantial service life of the entire bearing can be improved.

The double-row self-aligning roller bearing according to one embodiment of the present invention may further include two retainers that consist of a left-side retainer and a right-side retainer configured to retain the rollers in the left row and the rollers in the right row, respectively, and formed separately from each other, in which each of the left-side retainer and the right-side retainer may have an annular portion disposed between the rollers in the left row and the rollers in the right row and a plurality of pillar portions extending outward in a width direction from the annular portion and configured to retain the rollers, and in which a radial thickness of a cross-section of each pillar portion of the retainer that retains the rollers in the row having a longer roller length may be greater than that of the retainer that retains the rollers in the row having a shorter roller length.

The maximum diameter position of each roller having a longer length is at the bearing inner diameter side, and thus a location at which the roller is retained is not at the center, in the radial direction, of the retainer pillar portion and is shifted to the retainer inner diameter side. Thus, the radial thickness of the cross-section of each pillar portion of the retainer that retains the rollers in the row having a longer roller length is made greater than that of the retainer that retains the rollers in the row having a shorter roller length. Accordingly, the roller retaining ability of the retainer improves, and the rollers can be stably retained by the retainer.

In one embodiment of the present invention, each of the left and right two retainers may be in the form of a comb-shaped retainer in which the plurality of pillar portions are supported in a cantilever manner by the annular portion.

Specifically, the retainer that retains the rollers in the row having a longer roller length may have pillar portions each having an inner diameter end positioned on an inner diameter side relative to an inner diameter end of the annular portion. The rollers of the double-row self-aligning roller bearing each have a contact angle for which the center line of the roller is inclined relative to the radial direction, and thus each roller is located at the further inner diameter side as coming closer to the outer side in the width direction. Therefore, by locating the inner diameter end of each pillar portion on the inner diameter side relative to the inner diameter end of the annular portion, the pillar portion is in contact with the vicinity of the center, in the radial direction, of the outer peripheral surface of the roller, so that the stability of the rollers can be enhanced.

The double-row self-aligning roller bearing according to one embodiment of the present invention may further include a retainer configured to retain the rollers in the left row and the rollers in the right row, in which the retainer may be an integrated type retainer that has an annular portion disposed between the rollers in the left row and the rollers in the right row and a plurality of pillar portions extending leftward and rightward in a width direction from the annular portion and in which the rollers in the left row are retained between the pillar portions extending leftward and the rollers in the right row are retained between the pillar portions extending rightward.

In the case where the lengths of the left and right rollers are increased without changing the widths of the inner and outer rings in order to increase the load capacity of the entire bearing, the left and right rollers become closer to each other. The annular portion of the retainer is disposed between the left and right rollers that become closer to each other. Since the retainer is configured as an integrated type that retains the rollers in the left row and the rollers in the right row, and the annular portion is shared for both of the left and right rows, even when the left and right rollers become closer to each other, the thickness of the annular portion in the width direction can be sufficiently ensured as compared to a configuration in which the respective annular portions of a retainer for the left row and a retainer for the right row are aligned between the left and right rollers. Therefore, insufficient strength of the retainer is avoided, and the rollers can be stably retained by the retainer. As described above, by sharing the load in proportions corresponding to the load capacities of the rollers in the left and right rows, the surface pressures of the rollers in the left and right rows become uniform. Thus, even when the rollers in the left and right rows are retained by the integrated type retainer, each roller can be smoothly driven due to the retainer.

In one embodiment of the present invention, each of the rollers in the left and right rows may be an asymmetrical roller having a maximum diameter displaced from a center of a roller length thereof, and an intermediate flange configured to guide the rollers in the left and right rows may be provided on an outer peripheral surface of the inner ring and between the rollers in the left row and the rollers in the right row. In the case of the asymmetrical rollers, an induced thrust load is generated. The intermediate flange receives the induced thrust load. A combination of the asymmetrical rollers and the intermediate flange has good accuracy of guide of the rollers and thus is suitable for a bearing that rotates at high speed.

In one embodiment of the present invention, each of the rollers in the left and right rows may be a symmetrical roller having a maximum diameter positioned at a center of a roller length thereof. In this embodiment, a guide ring configured to: freely rotate relative the front wheel and a retainer configured to retain the rollers in the left and right rows; and guide the rollers in the left and right rows may be provided between the retainer and the inner ring.

When the rollers in the left and right rows are symmetrical rollers, an induced thrust load is not generated therein, and thus the intermediate flange can be omitted. Providing the guide ring instead of the intermediate flange, skew of the rollers can be inhibited.

The double-row self-aligning roller bearing may be used, for example, for supporting a main shaft of a wind turbine generator. On the double-row self-aligning roller bearing that supports the main shaft of the wind turbine generator, a radial load due to the weights of blades and a rotor head and an axial load due to wind force act, and loads having different magnitudes act on the left and right rows. Even in such a case where the loads acting on the left and right rows are different from each other, when the double-row self-aligning roller bearing is used, the load can be shared in proportions corresponding to the load capacities of the rollers in the left and right rows.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a cross-sectional view of a double-row self-aligning roller bearing according to an embodiment of the present invention;

FIG. 2 is a cross-sectional view as seen from the direction of an arrow II in FIG. 1;

FIG. 3 is a cross-sectional view as seen from the direction of an arrow III in FIG. 1;

FIG. 4 is an explanatory diagram of asymmetrical rollers;

FIG. 5 is a developed cross-sectional view of a retainer of the double-row self-aligning roller bearing;

FIG. 6A is a diagram showing an example of a cross-sectional shape of a left pillar portion of the retainer;

FIG. 6B is a diagram showing an example of a cross-sectional shape of a right pillar portion of the retainer;

FIG. 7A is a diagram showing another example of the cross-sectional shape of the left pillar portion of the retainer;

FIG. 7B is a diagram showing another example of the cross-sectional shape of the right pillar portion of the retainer;

FIG. 8A is a cross-sectional view of a double-row self-aligning roller bearing according to a variant of the embodiment;

FIG. 8B is a partially enlarged view of FIG. 8A;

FIG. 9 is a cross-sectional view of a double-row self-aligning roller bearing according to another embodiment of the present invention;

FIG. 10 is a cross-sectional view of a double-row self-aligning roller bearing according to still another embodiment of the present invention;

FIG. 11 is a cross-sectional view of a double-row self-aligning roller bearing according to still another embodiment of the present invention;

FIG. 12 is a cross-sectional view of a double-row self-aligning roller bearing according to still another embodiment of the present invention;

FIG. 13 is a cross-sectional view of a double-row self-aligning roller bearing according to still another embodiment of the present invention;

FIG. 14 is a cross-sectional view of a double-row self-aligning roller bearing according to still another embodiment of the present invention;

FIG. 15 is a cross-sectional view of a double-row self-aligning roller bearing according to still another embodiment of the present invention;

FIG. 16 is a developed cross-sectional view of a retainer of the double-row self-aligning roller bearing;

FIG. 17 is a partially cutaway perspective view of an example of a main shaft supporting device of a wind turbine generator;

FIG. 18 is a cutaway side view of the main shaft supporting device; and

FIG. 19 is a cross-sectional view of a double-row self-aligning roller bearing according to related art.

### DESCRIPTION OF EMBODIMENTS

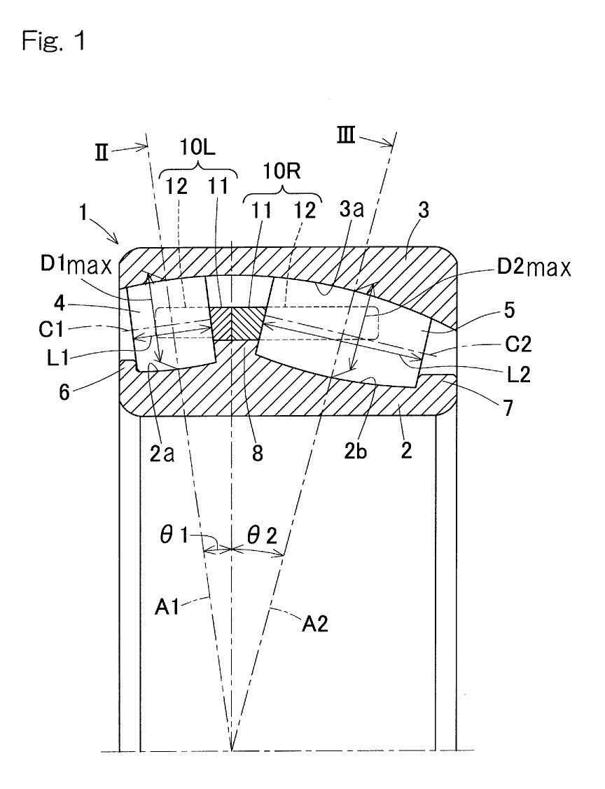

An embodiment of the present invention will be described with reference to FIG. 1 to FIG. 3. As shown in FIG. 1, a double-row self-aligning roller bearing 1 includes an inner ring 2, an outer ring 3, and two rows, which are arranged in a width direction, of rollers 4 and 5, that is, a left row of the rollers 4 and a right row of the rollers 5, interposed between the inner and outer rings 2 and 3. The outer ring 3 has a spherical raceway surface 3a, and the rollers 4 and in the left and right rows each have an outer peripheral surface having a cross-sectional shape along the raceway surface 3a of the outer ring 3. In other words, the outer peripheral surfaces of the rollers 4 and 5 are rotation curved surfaces obtained by rotating, about center lines (the axes of the rollers) C1 and C2, respective circular arcs along the raceway surface 3a of the outer ring 3. On the outer peripheral surface of the inner ring 2, raceway surfaces in double rows having cross-sectional shapes along the outer peripheral surfaces of the rollers 4 and 5 in the left and right rows, that is, a left-row raceway surface 2a and a right-row raceway surface 2b, are formed. The outer peripheral surface of the inner ring 2 has opposite ends provided with respective flanges 6 and 7. The outer peripheral surface of the inner ring 2 has a center portion, that is, a portion between the left-row raceway surface 2a and the right-row raceway surface 2b, provided with an intermediate flange 8. The terms “left” and “right” in the present specification indicate a relative positional relationship in the axial direction of the bearing, and coincide with left and right in each drawing, for easy understanding, in the following description.

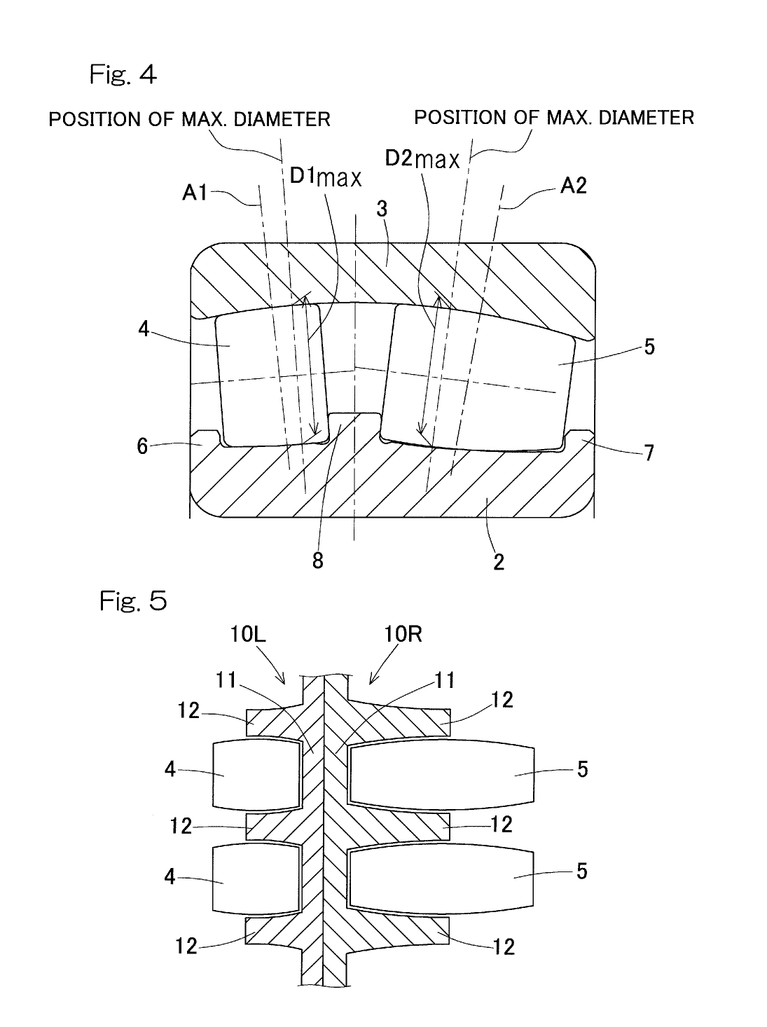

The rollers 4 and 5 in the left and right rows are asymmetrical rollers having respective maximum diameters D1ₘₐₓ and D2ₘₐₓ at positions displaced from centers A1 and A2 of the roller lengths thereof. As exaggeratedly shown in FIG. 4, the position of the maximum diameter D1ₘₐₓ of the rollers 4 in the left row is on the right side of the center A1 of the roller length, and the position of the maximum diameter D2ₘₐₓ of the rollers 5 in the right row is on the left side of the center A2 of the roller length. Induced thrust loads are generated in the rollers 4 and 5 in the left and right rows, which are in the form of such asymmetrical rollers. The intermediate flange 8 of the inner ring 2 is provided for receiving the induced thrust loads. A combination of the asymmetrical rollers and the intermediate flange guides the rollers 4 and 5 at three locations, that is, at the inner ring 2, the outer ring 3, and the intermediate flange 8, and thus has good guiding accuracy and is suitable for a bearing that rotates at high speed.

The rollers 4 in the left row and the rollers 5 in the right row have different lengths L1 and L2 along the center lines C1 and C2. The rollers 4 in the left row and the rollers 5 in the right row have respective contact angles θ1 and 02 that are greater than 0° and that are different from each other in opposite directions. In this example, the contact angle θ2 of the rollers 5 having the longer length L2 is set so as to be greater than the contact angle θ1 of the rollers 4 having the shorter length L. In this embodiment, the maximum diameter D1ₘₐₓ of the rollers 4 in the left row and the maximum diameter D2ₘₐₓ of the rollers 5 in the right row are equal to each other.

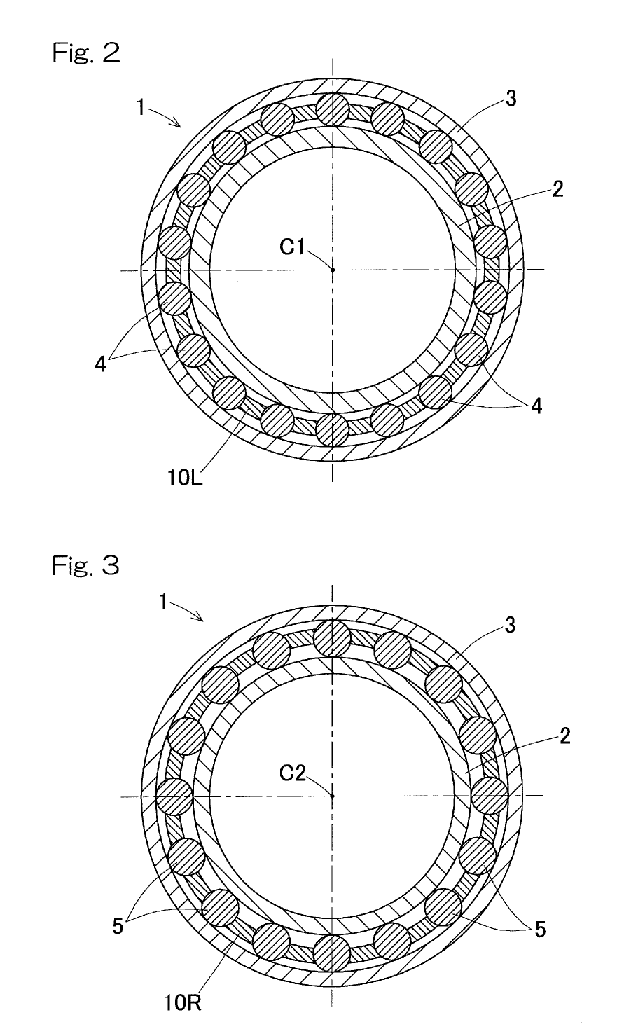

FIG. 2 is a cross-sectional view as seen from the direction of an arrow II in FIG. 1, and FIG. 3 is a cross-sectional view as seen from the direction of an arrow III in FIG. 1. As shown in FIG. 2 and FIG. 3, the number of the rollers 4 in the left row and the number of the rollers 5 in the right row are different from each other. In this example, the number of the rollers 4 in the left row having the shorter length L1 is 18, and the number of the rollers 5 in the right row having the longer length L2 is 16. These numbers are an example, and the numbers of the rollers 4 and 5 in the respective rows can be arbitrarily determined. The number of the rollers 5 having the longer length L2 may be greater than the number of the rollers 4 having the shorter length L1.

The rollers 4 and 5 in the left and right rows are respectively retained by a left-side retainer 10L for the left row and a right-side retainer 10R for the right row that are formed separately from each other. As shown in a developed cross-sectional view of FIG. 5, the left-side retainer 10L includes an annular portion 11 and a plurality of pillar portions 12 extend leftward from the annular portion 11, in which the rollers 4 in the left row are retained in pockets between these pillar portions 12. The right-side retainer 10R includes an annular portion 11 and a plurality of pillar portions 12 extending rightward from the annular portion 11, in which the rollers 5 in the right row are retained in pockets between these pillar portions 12. That is, each of the retainers 10L and 10R is a comb-shaped retainer in which the plurality of pillar portions 12 are supported in a cantilever manner by the annular portion 11.

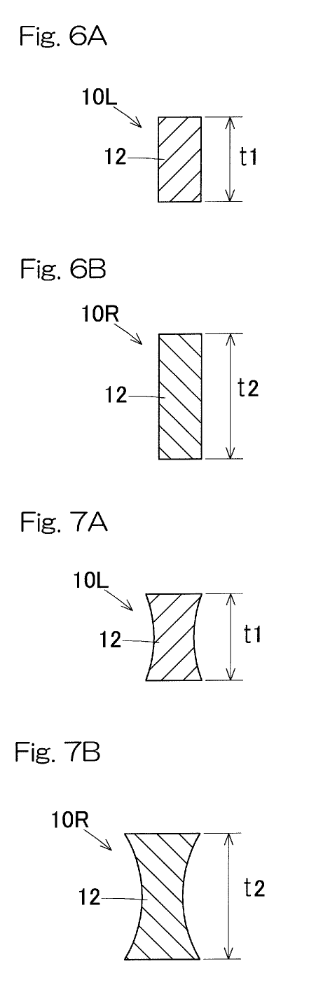

The cross-sectional shapes of surfaces, perpendicular to the longitudinal direction, of the pillar portions 12 of each of the respective retainers 10L and 10R may be rectangular as shown in FIGS. 6A and 6B, or may be shapes in which the side surfaces thereof with which the rollers 4 and 5 (FIG. 1) are in slidable contact may be formed as curved surfaces along the outer peripheral surfaces of the rollers 4 and 5 as shown in FIGS. 7A and 7B.

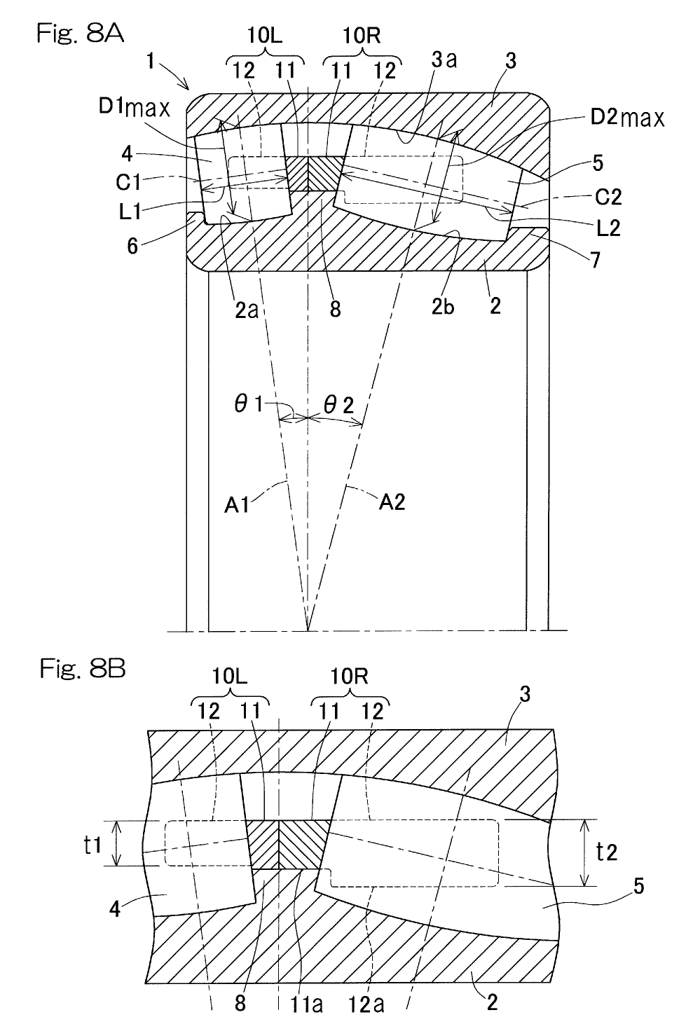

FIG. 8A and FIG. 8B that is a partially enlarged view of FIG. 8A, illustrate a variant of the present embodiment, in which when both retainers 10L and 10R are compared to each other, the radial thicknesses of cross-sections of respective annular portions 11 are equal to each other, but regarding the radial thicknesses of cross-sections of the pillar portions 12, a radial thickness t2 of each pillar portion 12 of the right-side retainer 10R is greater than a radial thickness t1 of each pillar portion 12 of the left-side retainer 10L. Specifically, the radial thickness t2 of each pillar portion 12 of the right-side retainer 10R is made greater with an inner diameter end 12a of the pillar portion 12 being positioned on the inner diameter side relative to an inner diameter end 11a of the annular portion 11.

By making the radial thickness t2 of each pillar portion 12 of the right-side retainer 10R, which retains the rollers 5 having the longer length L2, greater as described above, the roller retaining ability of the right-side retainer 10R improves. In addition, by positioning the inner diameter end 12a of each pillar portion 12 on the inner diameter side relative to the inner diameter end 11a of the annular portion 11, the roller retaining ability of the right-side retainer 10R further improves. The reason for this will be described. The rollers 5 in the right row have the contact angle θ2, by which the center line C2 of the roller is inclined relative to the radial direction, and thus each roller 5 is positioned such that it comes progressively closer to the inner diameter side toward the outer side in the width direction. Therefore, by positioning the inner diameter end 12a of each pillar portion 12 on the inner diameter side relative to the inner diameter end 11a of the annular portion 11, the pillar portion 12 is in contact with the vicinity of the center, in the radial direction, of the outer peripheral surface of the roller, so that the roller retaining ability of the right-side retainer 10R further improves. The configuration of the right-side retainer 10R is particularly effective when being applied to a comb-shaped retainer in which the roller retaining ability thereof is structurally not so high.

When the cross-section of each pillar portion 12 of the right-side retainer 10R, which retains the rollers 5 in the right row having the longer length L2 and a greater load capacity is increased in size, a possibility of damage of the right-side retainer 10R can be reduced.

The double-row self-aligning roller bearing 1 having this configuration may be used in an application in which loads having different magnitudes act on left and right rows, for example, in an application in which one row of the rollers receives an axial load and a radial load and the other row of the rollers receives almost only the radial load. Specifically, the double-row self-aligning roller bearing 1 is used, for example, as a bearing that supports a main shaft of a wind turbine generator, which will be described later.

In the case where the double-row self-aligning roller bearing 1 is used in the above applications, the rollers in the row that receives the axial load are made as the rollers 5 in the right row having the longer length L2, and the rollers in the row that hardly receives any of the axial load are made as the rollers 4 in the left row having the shorter length L1. In addition, the contact angle θ2 of the rollers 5 in the right row that receives the axial load is made greater than the contact angle θ1 of the rollers 4 in the left row that hardly receives any of the axial load. Thus, the rollers 5 having a greater load capacity and the longer length L2 receive both the axial load and the radial load, and the rollers 4 having a smaller load capacity and the shorter length L1 receive almost only the radial load.

Furthermore, by making the number of the rollers 4 in the left row and the number of the rollers 5 in the right row different from each other, the load capacities of the left and right rows are adjusted so as to be substantially equal to each other. In the case of this embodiment, as in FIG. 2 and FIG. 3, the number of the rollers 4 in the left row is made greater than the number of the rollers 5 in the right row. The rollers 4 in the left row having the shorter length L1 and the smaller contact angle θ1 are entirely located slightly on the outer diameter side relative to the rollers 5 in the right row having the longer length L2 and the greater contact angle θ2. Thus, in the case where the maximum diameters D1ₘₐₓ and D2ₘₐₓ of the rollers 4 and 5 are equal to each other, when the number of the rollers 4 in the left row is increased, trouble due to the rollers being too close to each other is more unlikely to occur than when the number of the rollers 5 in the right row is increased.

When the load capacities of the left and right roller rows are adjusted by employing the configuration in which the lengths of the rollers in the left and right rows are made different from each other and the configuration in which the numbers of the rollers in the left and right rows are made different from each other, in combination as described above, the degree of freedom in design becomes higher than when the load capacities of the left and right roller rows are adjusted only by employing the configuration in which the lengths of the rollers are made different from each other. Thus, the load can be shared in proportions corresponding to the load capacities of the rollers 4 and 5 in the left and right rows, even in a limited space in which the width dimension and the radial thickness are determined by standards. As a result, the surface pressures of the rollers 4 and 5 in the left and right rows become uniform. Accordingly, a large load capacity can be ensured in the entire bearing, and also the substantial service life of the entire bearing can be improved.

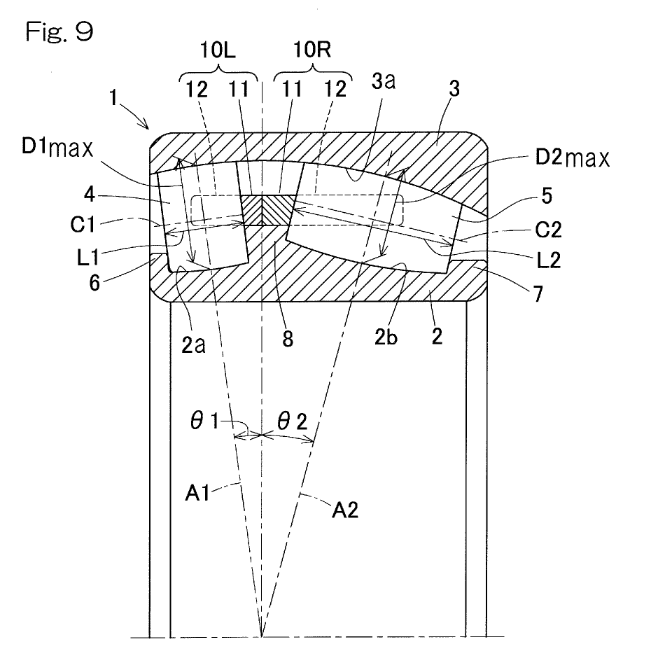

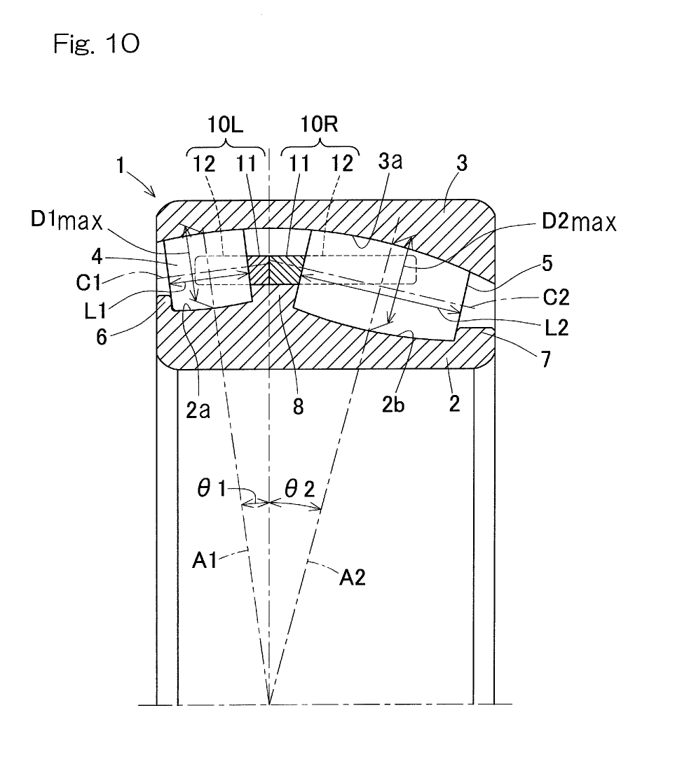

FIG. 9 and FIG. 10 each show other embodiments of the present invention. In the double-row self-aligning roller bearings 1 in FIG. 9 and FIG. 10, the lengths L1 and L2 of the rollers 4 and 5 in the left and right rows are different from each other, the numbers of the rollers 4 and 5 in the left and right rows are different from each other, and furthermore, respective maximum diameters D1ₘₐₓ and D2ₘₐₓ of the rollers 4 and 5 in the left and right rows are different from each other. In the double-row self-aligning roller bearing 1 in FIG. 9, the maximum diameter D1ₘₐₓ of the rollers 4 in the left row is greater than that the maximum diameter D2ₘₐₓ of the rollers 5 in the right row. On the other hand, in the double-row self-aligning roller bearing 1 in FIG. 10, the maximum diameter D2ₘₐₓ of the rollers 5 in the right row is greater than the maximum diameter D1ₘₐₓ of the rollers 4 in the left row.

Specifically, in the embodiment shown in FIG. 9, the diameter (for example, the maximum diameter D1ₘₐₓ) of the rollers 4 having the shorter length L1 is greater than the diameter (the maximum diameter D2ₘₐₓ) of the rollers 5 having the longer length L2. The lengths L1 and L2 and the maximum diameters D1ₘₐₓ and D2ₘₐₓ of the rollers 4 and 5 in the left and right rows are determined such that the load capacities of the rollers 4 and 5 in the left and right rows have appropriate magnitudes. In this example, the load capacity of the rollers 5 having the longer length L2 and the smaller maximum diameter D2ₘₐₓ is greater than that of the rollers 4 having the shorter length L and the greater maximum diameter D1ₘₐₓ.

Since the rollers 5 having the longer length L2 are entirely positioned on the inner diameter side relative to the rollers 4 having the shorter length L1, when the maximum diameters D1ₘₐₓ and D2ₘₐₓ of the left and right rollers 4 and are equal to each other, the thickness of the inner ring 2 has an allowance on the side at which the rollers 4 having the shorter length L1 are present. By utilizing the thickness allowance, it is possible to make the maximum diameter D1ₘₐₓ of the rollers 4 having the shorter length L1 greater than the maximum diameter D2ₘₐₓ of the rollers 5 having the longer length L2, even with the width dimension and the radial thickness determined by the standards.

By appropriately setting the lengths L1 and L2 and the maximum diameters D1ₘₐₓ and D2ₘₐₓ of the rollers 4 and 5, the load can be shared in proportions corresponding to the load capacities of the rollers 4 and 5 in the left and right rows. As a result, the surface pressures of the rollers 4 and 5 in the left and right rows become uniform. Accordingly, a large load capacity can be ensured in the entire bearing, and also the substantial service life of the entire bearing can be increased. In addition, the maximum diameter D1ₘₐₓ of the rollers 4 having the shorter length L1 is made greater than the maximum diameter D2ₘₐₓ of the rollers 5 having the longer length L2 by utilizing the structural features of the double-row self-aligning roller bearing 1 that the lengths L1 and L2 of the rollers 4 and 5 in the left and right rows are different from each other, whereby a further increase in load capacity is achieved.

Meanwhile, in the embodiment shown in FIG. 10, the maximum diameter D2ₘₐₓ of the rollers 5 having the longer length L2 is greater than the maximum diameter D1ₘₐₓ of the rollers 4 having the shorter length L1. Accordingly, the load capacity of the rollers 5 having the longer length L2 is greater than the load capacity of the rollers 4 having the shorter length L1, by more than the difference between the roller lengths L1 and L2.

By appropriately setting the lengths L1 and L2 and the maximum diameters D1ₘₐₓ and D2ₘₐₓ of the rollers 4 and 5, the load can be shared in proportions corresponding to the load capacities of the rollers 4 and 5 in the left and right rows. As a result, the surface pressures of the rollers 4 and 5 in the left and right rows become uniform. Accordingly, a large load capacity can be ensured in the entire bearing, and also the substantial service life of the entire bearing can be improved.

In the double-row self-aligning roller bearing 1, by making the maximum diameter D2ₘₐₓ of the roller 5 having the longer length L2 greater than the maximum diameter D1ₘₐₓ of the rollers 4 having a shorter length, the load capacity of the rollers 5 having the longer length L2 is made greater than the load capacity of the rollers 4 having the shorter length L1, by more than the difference between the roller lengths L1 and L2. Thus, in the case of setting the load capacities of the left and right rollers 4 and 5 to have an appropriate ratio, the lengths of the rollers 4 having a smaller load capacity do not need to be made shorter than necessary. That is, the rollers 4 do not need to be made into a short shape in which the length L1 is shorter than the maximum diameter D1ₘₐₓ. Therefore, rotation stability of the rollers 4 can be maintained.

By making the maximum diameters D1ₘₐₓ and D2ₘₐₓ of the rollers 4 and 5 in the left and right rows different from each other as described above, the ratio between the load capacity of all the rollers 4 in the left row and the load capacity of all the rollers 5 in the right row changes as compared to the case where the maximum diameters of the rollers 4 and 5 in the left and right rows are equal to each other. That is, the load capacity of the roller row increases as the maximum diameter of the rollers increases. By using the method in which the maximum diameters D1ₘₐₓ and D2ₘₐₓ of the rollers 4 and 5 in the left and right rows are made different from each other in addition to the method in which the lengths L1 and L2 of the rollers 4 and 5 in the left and right rows are made different from each other and the method in which the numbers of the rollers 4 and 5 in the left and right rows are made different from each other, the degree of freedom in design becomes higher, so that the load can be more easily shared in proportions corresponding to the load capacities of the rollers 4 and 5 in the left and right rows while a large load capacity is ensured in the entire bearing. In the present embodiment, the example has been described in which the maximum diameter is used as a diameter serving as a reference for the rollers in the left and right rows and the maximum diameters of the rollers 4 and 5 in the left and right rows are made different from each other. However, in the case where the load can be shared in proportions corresponding to the load capacities of the rollers 4 and 5 in the left and right rows, roller diameters other than the maximum diameters, for example, the minimum diameters of the rollers in the left and right rows may be made different from each other.

In the case where the maximum diameter D1ₘₐₓ of the rollers 4 in the left row is greater as in FIG. 9, the number of the rollers 4 in the left row is preferably smaller than the number of the rollers 5 in the right row, due to an arrangement space in the circumferential direction. Similarly, in the case where the maximum diameter D2ₘₐₓ of the rollers 5 in the right row is greater as shown in FIG. 10, the number of the rollers 5 in the right row is preferably smaller than the number of the rollers 4 in the left row.

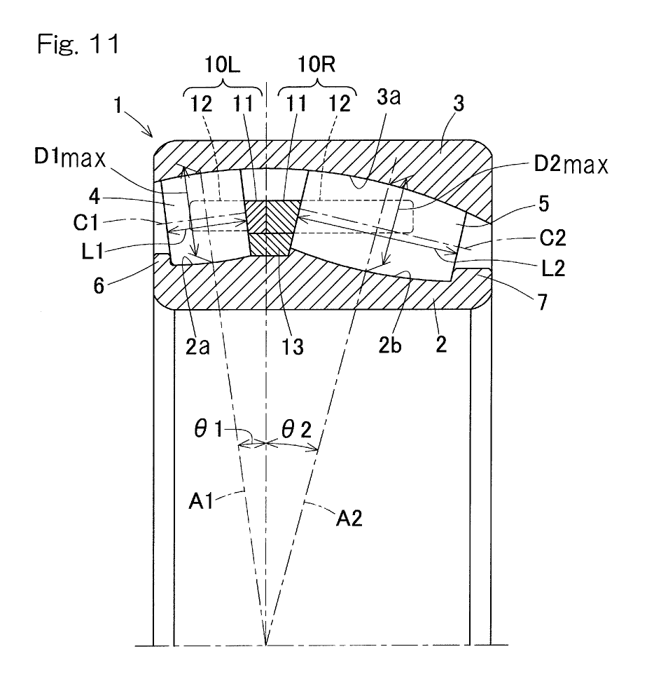

FIG. 11 shows a still different embodiment of the present invention. In the double-row self-aligning roller bearing 1 in FIG. 11, the left and right rollers 4 and 5 are symmetrical rollers in which the positions of the maximum diameters D1ₘₐₓ and D2ₘₐₓ are located at the centers A1 and A2 of the roller lengths thereof. In the rollers 4 and 5 composed of symmetrical rollers, an induced thrust load is not generated. Thus, the intermediate flange that is provided in the inner ring 2 of each embodiment described above is omitted. That is, the portion of the outer peripheral surface of the inner ring 2 between the left-row raceway surface 2a and the right-row raceway surface 2b is formed as a flat peripheral surface on which a projection such as an intermediate flange is not present. Furthermore, instead of the intermediate flange, a guide ring 13 that freely rotates relative to the inner ring 2 and retainers 10L and 10R and that guides the rollers 4 and 5 in the left and right rows is provided between the inner ring 2 and the retainers 10L and 10R. By providing the guide ring 13, skew of the rollers 4 and 5 can be inhibited.

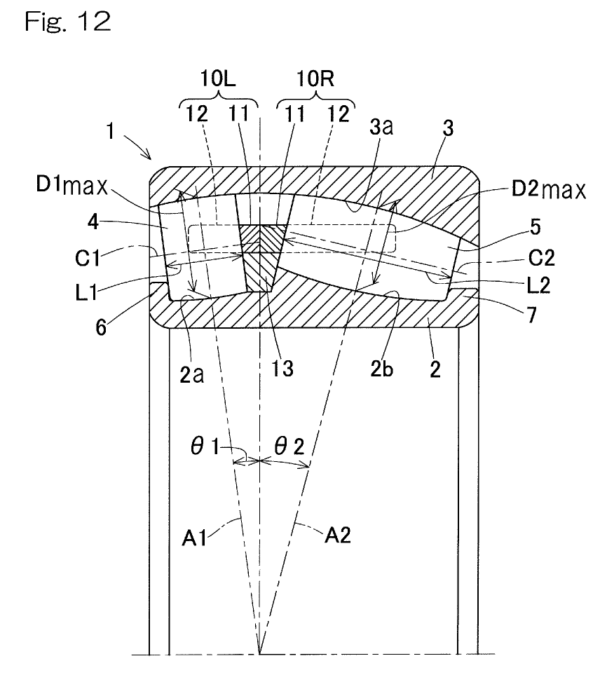

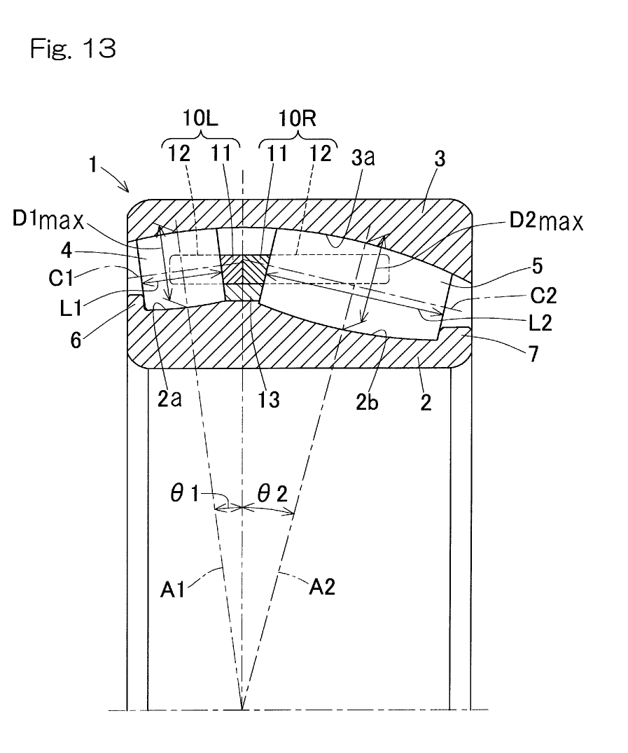

FIG. 11 shows an example in which the maximum diameters D1ₘₐₓ and D2ₘₐₓ of the rollers 4 and 5 in the left and right rows are equal to each other. However, also in the case where the maximum diameters D1ₘₐₓ and D2ₘₐₓ of the rollers 4 and 5 in the left and right rows are different from each other, the guide ring 13 can be similarly provided instead of the intermediate flange. FIG. 12 shows an example of the double-row self-aligning roller bearing 1 in which the maximum diameter D1ₘₐₓ of the rollers 4 having the shorter length L1 is set so as to be greater than the maximum diameter D2ₘₐₓ of the rollers 5 having the longer length L2 and the guide ring 13 is provided, and FIG. 13 shows an example of the double-row self-aligning roller bearing 1 in which the maximum diameter D2ₘₐₓ of the rollers 5 having the longer length L2 is set so as to be greater than the maximum diameter D1ₘₐₓ of the rollers 4 having the shorter length L1 and the guide ring 13 is provided.

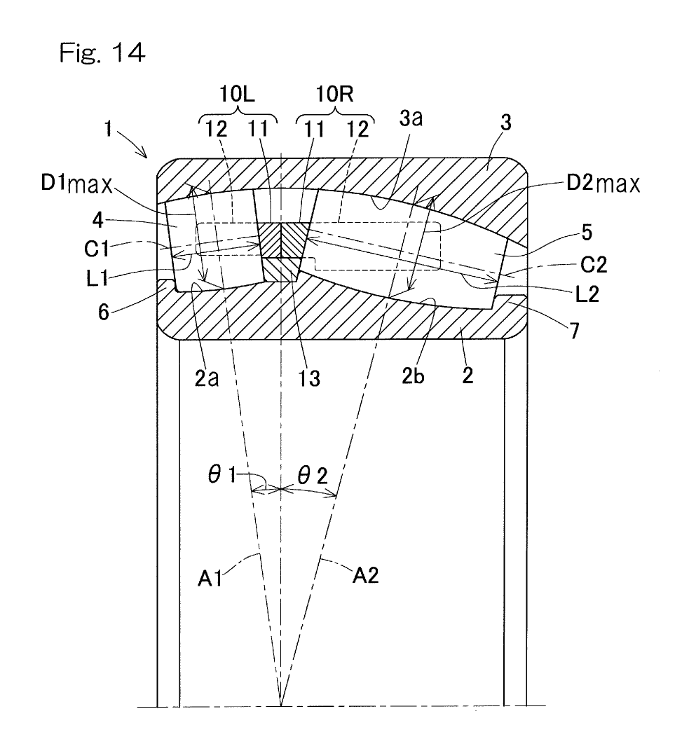

FIG. 11 shows an example in which the radial thicknesses of the cross-sections of the pillar portions 12 of both retainers 10L and 10R are equal to each other. However, also in the case where, regarding the radial thicknesses of the cross-sections of the pillar portions 12 of both retainers 10L and 10R, the radial thickness t2 of each pillar portion 12 of the right-side retainer 10R is made greater than the radial thickness t1 of each pillar portion 12 of the left-side retainer 10L as shown in FIG. 14, the guide ring 13 can be similarly provided instead of the intermediate flange.

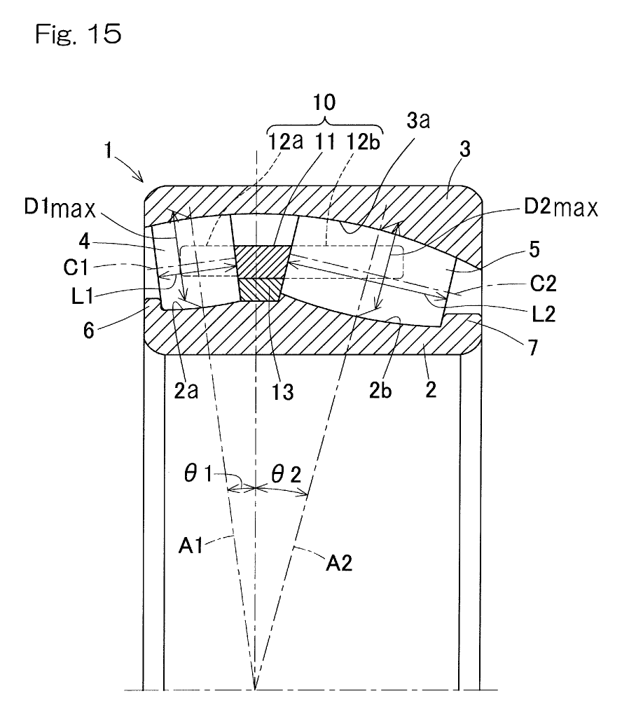

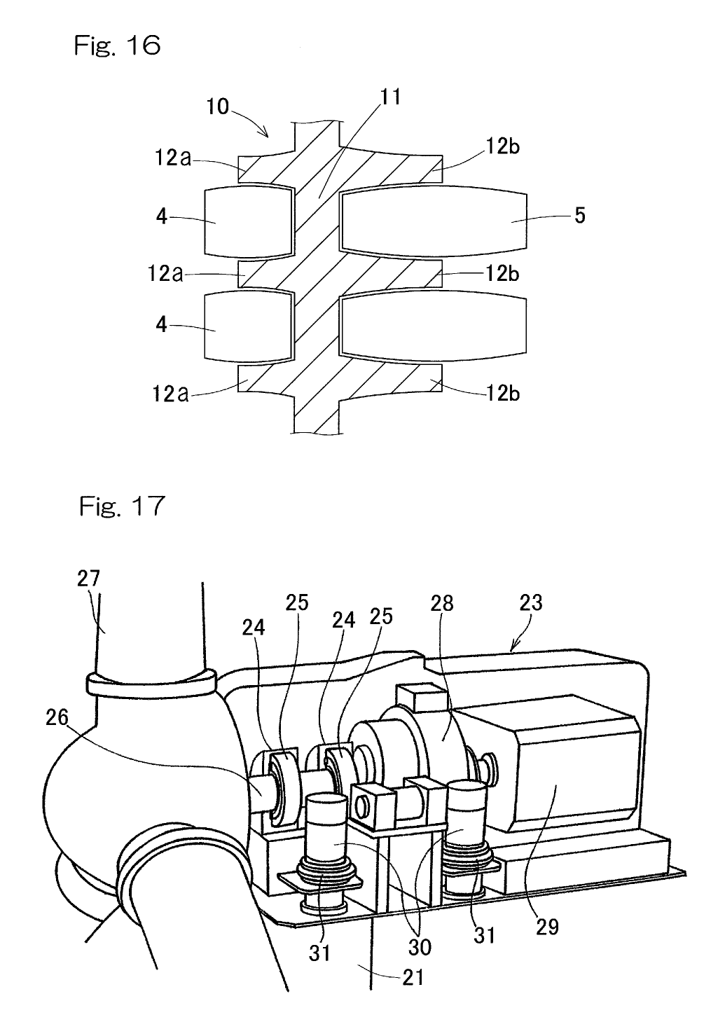

As shown in FIG. 15, the rollers 4 and 5 in the left and right rows may be retained by a retainer 10 formed integrally at the left and right sides. As shown in a developed cross-sectional view of FIG. 16, the retainer 10 has a comb shape in which a plurality of pillar portions 12a and 12b extend leftward and rightward, respectively, from an annular portion 11 located between the rollers 4 and 5 in the left and right rows. The rollers 4 in the left row are retained in pockets between the left-side pillar portions 12a, and the rollers 5 in the right row are retained in pockets between the right-side pillar portions 12b. That is, the retainer 10 is an integrated type retainer that retains the rollers 4 and 5 in the left and right rows. Such an integrated type retainer 10 has an advantage in having high strength, since the thickness of the annular portion 11 in the width direction can be large, as compared to a configuration in which the respective annular portions of a retainer for the left row and a retainer for the right row are aligned between the left and right rollers 4 and 5.

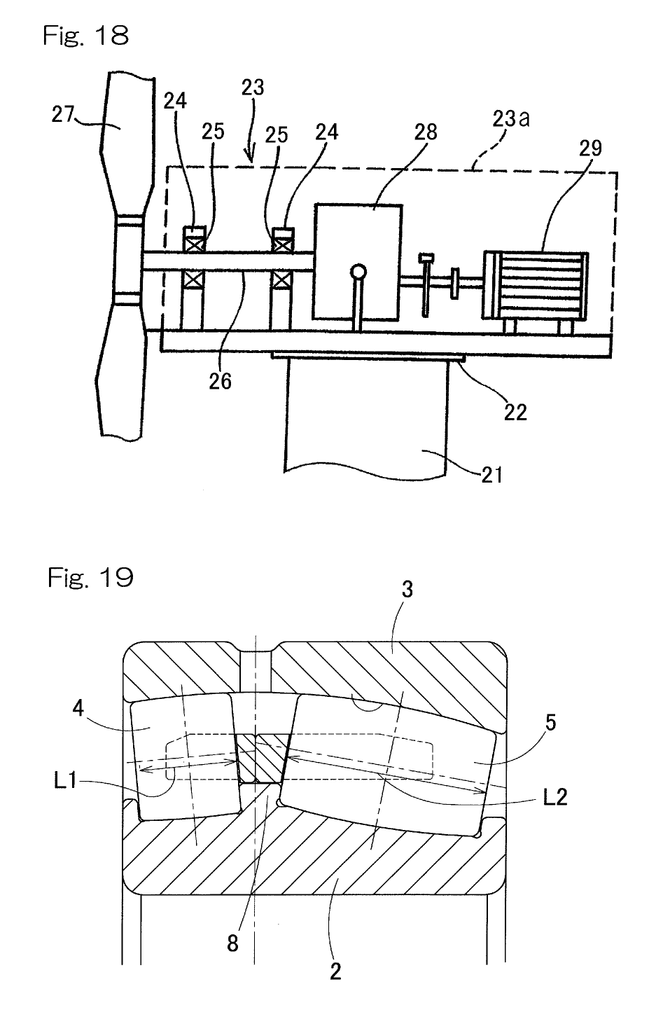

FIG. 17 and FIG. 18 show an example of a main shaft supporting device of a wind turbine generator. A casing 23a of a nacelle 23 is provided on a support stand 21 via a slewing rim bearing 22 (FIG. 18) so as to be horizontally slewable. A main shaft 26 is rotatably provided within the casing 23a of the nacelle 23 via main shaft supporting bearings 25 provided in bearing housings 24. Blades 27 as a swirler are mounted on a portion of the main shaft 26 that projects outside the casing 23a. The other end of the main shaft 26 is connected to a speed increaser 28, and an output shaft of the speed increaser 28 is connected to a rotor shaft of a generator 29. The nacelle 23 is slewed at an arbitrary angle via a speed reducer 31 by a slewing motor 30.

The two main shaft supporting bearings 25 are aligned in the illustrated example, but the number of main shaft supporting bearings 25 may be one. The double-row self-aligning roller bearing 1 of any of the respective embodiments described above is used as each main shaft supporting bearing 25. In this case, both a radial load and an axial load act on the row located farther from the blades 27, and thus the rollers 5 having the greater contact angle θ2 and the longer length L2 are used as the rollers in the row located farther from the blades 27. Only the radial load mainly acts on the row located closer to the blades 27, and thus the rollers 4 having the smaller contact angle θ1 and the shorter length L1 are used as the rollers in the row located closer to the blades 27.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

Even in the following application modes in which the numbers of rollers in left and right rows are equal to each other in each embodiment described above, the technical advantages due to each of the above-described configurations other than those due to the configuration in which the numbers of the rollers in the left and right rows are different from each other can be obtained, although the application modes are not included in the scope of the present invention.

[Application Mode 1]

A double-row self-aligning roller bearing comprising rollers interposed in left and right rows between an inner ring and an outer ring, the outer ring having a spherical raceway surface, each of the rollers in the left and right rows having an outer peripheral surface having a cross-sectional shape along the raceway surface of the outer ring, wherein

a length of each roller in the left row and a length of each roller in the right row are different from each other, the double-row self-aligning roller bearing has a retainer configured to both the rollers in the left row and the rollers in the right row, and the retainer is an integrated type retainer that has an annular portion disposed between the rollers in the left row and the rollers in the right row and a plurality of pillar portions extending leftward and rightward in a width direction from the annular portion and in which the rollers in the left row are retained between the pillar portions extending leftward and the rollers in the right row are retained between the pillar portion extending rightward.

[Application Mode 2]

The double-row self-aligning roller bearing according to application mode 1, wherein the rollers in the left and right rows are symmetrical rollers in each of which a position of a maximum diameter is located at a center of a roller length thereof, and an intermediate flange is not present on a portion of an outer peripheral surface of the inner ring between the rollers in the left row and the rollers in the right row.

[Application Mode 3]

The double-row self-aligning roller bearing according to application mode 2, wherein a guide ring configured to freely rotate relative to the inner ring and the retainer and guide the rollers in the left and right rows is provided between the inner ring and the retainer.

[Application Mode 4]

A double-row self-aligning roller bearing comprising rollers interposed in left and right rows between an inner ring and an outer ring, the outer ring having a spherical raceway surface, each of the rollers in the left and right rows having an outer peripheral surface having a cross-sectional shape along the raceway surface of the outer ring, wherein

a length of each roller in the left row and a length of each roller in the right row are different from each other, and a diameter of each roller having a longer length is greater than a diameter of each roller having a shorter length.

[Application Mode 5]

The double-row self-aligning roller bearing according to application mode 4, wherein the rollers in the left and right rows are symmetrical rollers in each of which a position of a maximum diameter is located at a center of a roller length thereof, an intermediate flange is not present on an outer peripheral surface of the inner ring and between the rollers in the left row and the rollers in the right row, and a guide ring configured to: freely rotate relative to the inner ring and a retainer configured to retain the rollers in the left and right rows; and guide the rollers in the left and right rows is provided between the retainer and the inner ring.

[Application Mode 6]

A double-row self-aligning roller bearing comprising rollers interposed in left and right rows between an inner ring and an outer ring, the outer ring having a spherical raceway surface, each of the rollers in the left and right rows having an outer peripheral surface having a cross-sectional shape along the raceway surface of the outer ring, wherein

a length of each roller in the left row and a length of each roller in the right row are different from each other, and a diameter of each roller having a shorter length is greater than a diameter of each roller having a longer length.

[Application Mode 7]

The double-row self-aligning roller bearing according to application mode 6, wherein the rollers in the left and right rows are symmetrical rollers in each of which a position of a maximum diameter is located at a center of a roller length thereof, an intermediate flange is not present on an outer peripheral surface of the inner ring and between the rollers in the left row and the rollers in the right row, and a guide ring configured to: freely rotate relative to the inner ring and a retainer configured to retain the rollers in the left and right rows; and guide the rollers in the left and right rows is provided between the retainer and the inner ring.

[Application Mode 8]

A double-row self-aligning roller bearing comprising rollers interposed in left and right rows between an inner ring and an outer ring, the outer ring having a spherical raceway surface, each of the rollers in the left and right rows having an outer peripheral surface having a cross-sectional shape along the raceway surface of the outer ring, wherein

a length of each roller in the left row and a length of each roller in the right row are different from each other, the double-row self-aligning roller bearing has left and right two retainers configured to retain the rollers in the left row and the rollers in the right row, respectively, each of the left and right two retainers has an annular portion disposed between the rollers in the left row and the rollers in the right row and a plurality of pillar portions extending outward in a width direction from the annular portion, the rollers in the left row or the rollers in the right row are retained between the pillar portions, and a radial thickness of a cross-section of each pillar portion of the retainer that retains the rollers in the row having a longer roller length is greater than that of the retainer that retains the rollers in the row having a shorter roller length.

[Application Mode 9]

The double-row self-aligning roller bearing according to application mode 8, wherein each of the left and right two retainers is a comb-shaped retainer in which the plurality of pillar portions are supported in a cantilever manner by the annular portion.

[Application Mode 10]

The double-row self-aligning roller bearing according to application mode 9, wherein, in the retainer that retains the rollers in the row having a longer roller length, an inner diameter end of each pillar portion is located at an inner diameter side relative to an inner diameter end of the annular portion.

### REFERENCE NUMERALS

1 . . . Double-row self-aligning roller bearing
2 . . . Inner ring
3 . . . Outer ring
3a . . . Raceway surface of outer ring
4, 5 . . . Roller
8 . . . Intermediate flange
10 . . . Retainer
10L . . . Left-side retainer
10R . . . Right-side retainer
13 . . . Guide ring
26 . . . Main shaft
A1, A2 . . . Center of roller length
D1ₘₐₓ, D2ₘₐₓ . . . Maximum diameter
L1, L2 . . . Roller length

What is claimed is:

1. A double-row self-aligning roller bearing comprising:
an inner ring;
an outer ring having a spherical raceway surface; and
rollers in a left row and rollers in a right row interposed between the inner ring and the outer ring,
the rollers in the left row and the rollers in the right row each having an outer peripheral surface of a cross-sectional shape along the raceway surface of the outer ring,
wherein a length of each roller in the left row and a length of each roller in the right row are different from each other, and
the number of the rollers in the left row and the number of the rollers in the right row are different from each other.

2. The double-row self-aligning roller bearing as claimed in claim 1, wherein a maximum diameter of each roller in the left row and a maximum diameter of each roller in the right row are different from each other.

3. The double-row self-aligning roller bearing as claimed in claim 2, wherein the maximum diameter of each roller having a shorter length is greater than the maximum diameter of each roller having a longer length.

4. The double-row self-aligning roller bearing as claimed in claim 2, wherein the maximum diameter of each roller having a longer length is greater than the maximum diameter of each roller having a shorter length.

5. The double-row self-aligning roller bearing as claimed in claim 1, further comprising two retainers that consist of a left-side retainer and a right-side retainer configured to retain the rollers in the left row and the rollers in the right row, respectively, and formed separately from each other,
wherein each of the left-side retainer and the right-side retainer has an annular portion disposed between the rollers in the left row and the rollers in the right row and a plurality of pillar portions extending outward in a width direction from the annular portion and configured to retain the rollers, and
wherein a radial thickness of a cross-section of each pillar portion of the retainer that retains the rollers in the row having a longer roller length is greater than that of the retainer that retains the rollers in the row having a shorter roller length.

6. The double-row self-aligning roller bearing as claimed in claim 5, wherein each of the left and right two retainers is in the form of a comb-shaped retainer in which the plurality of pillar portions are supported in a cantilever manner by the annular portion.

7. The double-row self-aligning roller bearing as claimed in claim 6, wherein, the retainer that retains the rollers in the row having a longer roller length has pillar portions each having an inner diameter end positioned on an inner diameter side relative to an inner diameter end of the annular portion.

8. The double-row self-aligning roller bearing as claimed in claim 1, further comprising a retainer configured to retain the rollers in the left row and the rollers in the right row, wherein
the retainer is an integrated type retainer that has an annular portion disposed between the rollers in the left row and the rollers in the right row and a plurality of pillar portions extending leftward and rightward in a width direction from the annular portion and in which the rollers in the left row are retained between the pillar portions extending leftward and the rollers in the right row are retained between the pillar portions extending rightward.

9. The double-row self-aligning roller bearing as claimed in claim 1, wherein each of the rollers in the left and right rows is an asymmetrical roller having a maximum diameter displaced from a center of a roller length thereof, and an intermediate flange configured to guide the rollers in the left and right rows is provided on an outer peripheral surface of the inner ring and between the rollers in the left row and the rollers in the right row.

10. The double-row self-aligning roller bearing as claimed in claim 1, wherein each of the rollers in the left and right rows is a symmetrical roller having a maximum diameter positioned at a center of a roller length thereof.

11. The double-row self-aligning roller bearing as claimed in claim 10, further comprising:
a retainer configured to retain the rollers in the left row and the rollers in the right row; and
a guide ring provided between the inner ring and the retainer and configured to freely rotate relative to the retainer and the inner ring and guide the rollers in the left row and the rollers in the right row.

12. The double-row self-aligning roller bearing as claimed in claim 1, wherein the double-row self-aligning roller bearing is used for supporting a main shaft of a wind turbine generator.
